(19) United States
(12) Patent Application Publication
(10) Pub. No.: US 2011/0246562 A1
(43) Pub. Date: Oct. 6, 2011

(54) VISUAL COMMUNICATION METHOD IN A MICROBLOG

(75) Inventor: Hang-Bong KANG, Seoul (KR)

(73) Assignee: CATHOLIC UNIVERSITY INDUSTRY ACADEMIC COOPERATION FOUNDATION, Seoul (KR)

(21) Appl. No.: 13/074,460

(22) Filed: Mar. 29, 2011

(30) Foreign Application Priority Data
Apr. 1, 2010 (KR) 10-2010-0029669

(51) Int. Cl. G06F 15/16

(52) U.S. Cl. 709/203

(57) ABSTRACT

A visual communication method adapted to microblogs is provided. The visual communication method comprises analyzing, by a server, a user's input text using context and words, extracting, by the server, a picture corresponding to the text using a multimedia classification system data base, creating, by the server, an avatar representing the user, synthesizing, by the server, the picture and the avatar into one multimedia form, and transferring, by the server, the synthesized multimedia to the user's microblog.

### PRIORITY

This application claims the benefit under 35 U.S.C. §119(a) of a Korean patent application filed on Apr. 1, 2010 in the Korean Intellectual Property Office and assigned Serial No. 10-2010-0029669, the entire disclosure of which is hereby incorporated by reference.

### BACKGROUND OF THE INVENTION

1. Field of the Invention

The present invention relates to communication methods. More particularly, the present invention relates to a method that creates one multimedia form based on a user's input text or a picture of a user's face and allows the user to intuitively and realistically perform visual communication in a micro-blog.

2. Description of the Related Art

Like the posting process in traditional blogs, microblogs allow users to post and store short text messages, similar to those transmitted via mobile devices, to a website, and allow other users to read them. Microblogs are widely used, serving as a new communication means. A microblog is also called a twitter because the twitter website, www.twitter.com, was the first to offer a micro-blogging service.

A twitter serves as a stoical network service that is suitable for mobile devices such as mobile phones, smart phones, etc., rather than wired internet systems. Tweets are differentiated from text messages or blogs. Since tweets are simple, they can be rapidly posted to a website. Twitters can be variously utilized due to a number of applications. Twitters have features in terms of platform, such as a stoical networking configuration, a mobile environment, extendibility via links, real-time search, various types of application by outside developers, etc.

However, since a conventional twitter allows for tweets that are text-based posts of up to 140 characters to meet mobile devices and it is difficult for users to input tweets. In addition, a conventional twitter lists tweets diffusely together with replies, so that information in microblogs cannot be utilized. In particular, a conventional twitter including only texts does not provide character contents representing users, so that the users cannot configure or show their microblogs with features.

### SUMMARY OF THE INVENTION

Aspects of the present invention are to address at least the above-mentioned problems and/or disadvantages and to provide at least the advantages described below. Accordingly, an aspect of the present invention is to provide a visual communication method that can allow a user to intuitively and easily post his/her message in a microblog by using a visual communication technique.

Another aspect of the present invention is to provide a visual communication method that can extract a tweet corresponding to a particular category from a microblog, create a paper or digital story book, and allow for the use of information in the microblog.

Another aspect of the present invention is to provide a visual communication method that can produce an avatar serving as a virtual character representing a user, and can allow the avatar to express feelings and motion, so that users can show microblogs with features and use them.

In accordance with an aspect of the present invention, a visual communication method in a microblog where a user inputs text and another user views it in real-time is provided. The method is performed in such a manner that the sever includes analyzes a user's input text using context and words, extracts a picture corresponding to the text using a multimedia classification system data base (DB), creates an avatar representing the user, synthesizes the picture and the avatar into one multimedia form, and transfers the synthesized multimedia to the user's microblog.

Preferably, the creation of an avatar comprises detecting a user's feeling corresponding to the text using the multimedia classification system DB, and creating an avatar having a facial expression corresponding to the feeling.

Preferably, the creation of an avatar comprises receiving the user's face picture, recognizing and analyzing a facial expression in the face picture and detecting a feeling, and creating an avatar having a facial expression corresponding to the feeling.

Preferably, the method may be further performed in such a manner that the server receives display information regarding a microblog user's electronic device that accessed the user's microblog, analyzes characteristics of the multimedia and extracting a feature of the multimedia from the characteristics, re-adjusts the multimedia to meet the display information in such a manner to preserve the feature, and transfers the re-adjusted multimedia to the microblog user's electronic device.

Preferably, the method may be further performed in such a manner that the server stores the multimedia, classifies the multimedia using a category classification system data base (DB), produces the multimedia in a paper book or digital story book format, according to classification, and transfers the paper book or digital story book to a microblog website.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a diagram that describes a visual communication method adapted to microblogs, according to an exemplary embodiment of the present invention;

FIG. 2 illustrates a flow chart that describes a visual communication method adapted to microblogs, according to a first embodiment of the present invention;

FIG. 3 illustrates a multimedia classification system DB that describes a visual communication method adapted to microblogs, according to an exemplary embodiment of the present invention;

FIG. 4 illustrates a view of an avatar that describes a visual communication method adapted to microblogs, according to an exemplary embodiment of the present invention;

FIG. 5 illustrates a view of an avatar that describes a visual communication method adapted to microblogs, according to another exemplary embodiment of the present invention;

FIG. 6 illustrates a flow chart that describes in detail step S300 in the visual communication method shown in FIG. 2, according to an exemplary embodiment of the present invention;

FIG. 7 illustrates one form of multimedia that describes a visual communication method adapted to microblogs according to an exemplary embodiment of the present invention;

FIG. 8 illustrates a flow chart that describes in detail step S300 in the visual communication method shown in FIG. 2, according to another exemplary embodiment of the present invention;

FIG. 9 illustrates a flow chart that describes a visual communication method adapted to microblogs, according to a second embodiment of the present invention;

FIG. 10 illustrates a flow chart that describes a visual communication method adapted to microblogs, according to a third embodiment of the present invention; and

FIG. 11 illustrates a category classification system DB that describes a visual communication method adapted to microblogs, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted to for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this application, it will be understood that when an element is referred to as being “connected” or “coupled” to another element, it can be directly connected or coupled to the other element or intervening elements may be present. It will be further understood that the terms “includes,” “comprises,” “including” and/or “comprising,” specify the presence of stated features, integers, steps, operations, elements, and/or components, but do not preclude the presence or addition of one or more other features, integers, steps, operations, elements, components, and/or groups thereof.

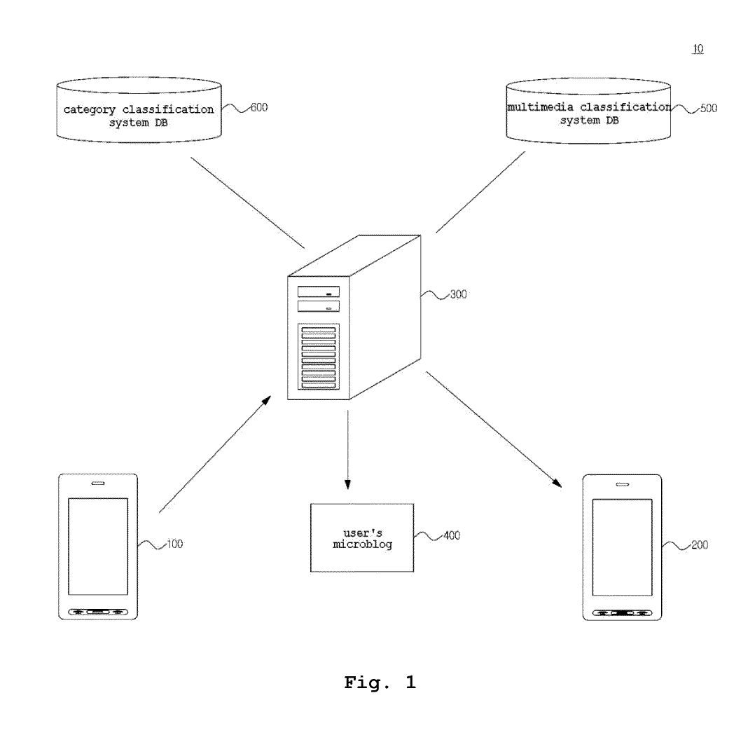

FIG. 1 illustrates a diagram that describes a visual communication method adapted to microblogs, according to an exemplary embodiment of the present invention. Referring to FIG. 1, the visual communication method adapted to microblogs is adapted to a system 10 that includes a first user's electronic device 100, a second user's electronic device 200, a server 300, a first user's microblog 400, a multimedia classification system data base (DB) 500, and a category classification system data base (DB) 600.

The first user's electronic device 100 transfers a text that the first user intends to post to the server 300. The first user's electronic device 100 includes devices that can access a network, such as smart phones, computers, PDAs, etc.

The second user's electronic device 200 refers to an electronic device that the second user intends to use to access the first user's microblog 400. Like the first user's electronic device 100, the second user's electronic device 200 includes devices that can access a network. Although the embodiment of the invention is described based on one second user with an electronic device 200, it should be understood that the invention is not limited to the embodiment. That is, since the first user's microblog 400 may be accessed by multiple users, the embodiment may be modified in such a manner to include a number of second user's electronic devices.

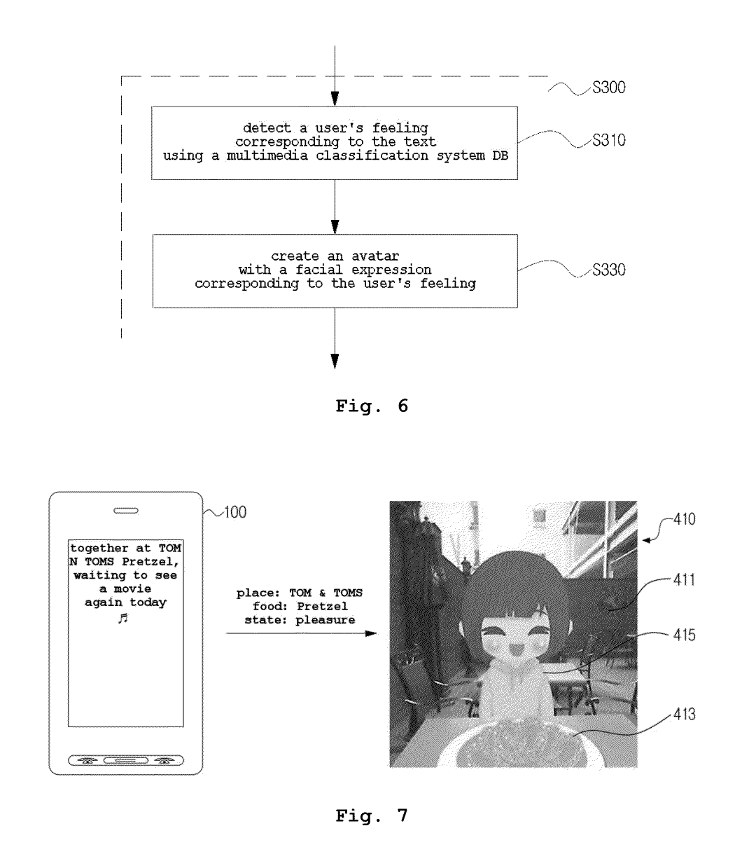

The server 300 receives a text from the first user's electronic device 100, converts it to multimedia 410, as shown in FIG. 7, and displays it on the first user's microblog 400. The server 300 also transfers the multimedia 410 to the second user's electronic device 200. The server 300 can receive texts from the first user's electronic device 100 as long as it can transmit them.

The first user's microblog 400 includes web pages to which multimedia 410, converted from the first user's transferred texts, is uploaded. The first user's microblog 400 may be configured in the same form as conventional microblogs, however, it may be configured with simple frames by omitting menus at both right and left sides in order to intuitively perform visual communication via the multimedia 410.

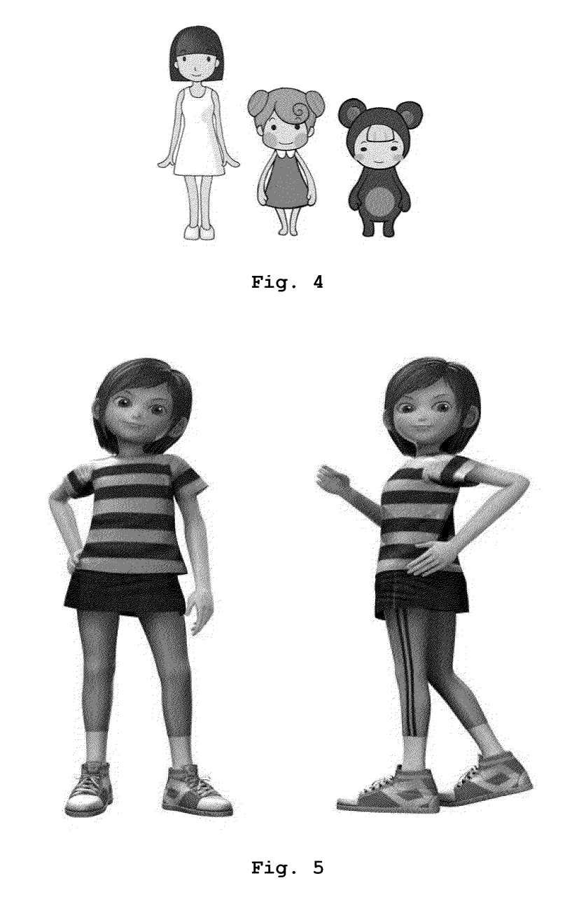

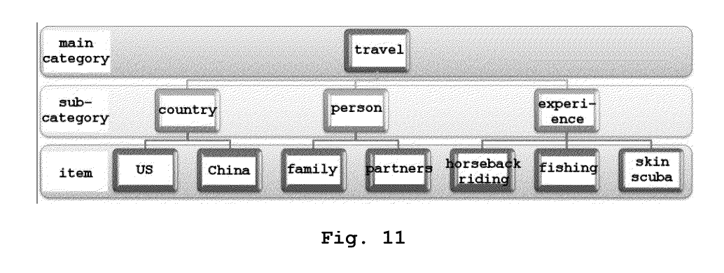

The multimedia classification system DB 500 will be described in detail later referring to FIG. 3. The category classification system DB 600 will also be described in detail later referring to FIG. 11.

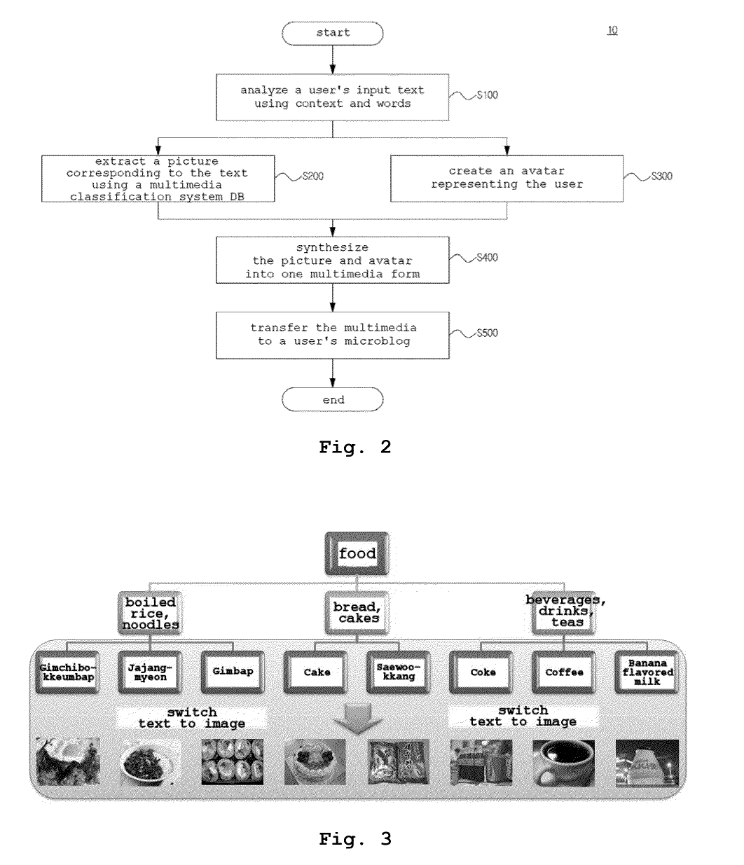

FIG. 2 illustrates a flow chart that describes a first embodiment of a visual communication method adapted to microblogs, according to an exemplary embodiment of the present invention. Referring to FIG. 2, the visual communication method of the first embodiment is performed in such a manner that the server 300 analyzes a user's input text using the context and words at step S100, extracts a picture corresponding to the text using multimedia classification system DB at step S200, creates an avatar representing the user at step S300, synthesizes the picture and avatar into one multimedia form at step S400, and transfers the multimedia to a user's microblog at step S500.

At step S100, the server 300 analyzes a user's input text using the context and words. The first user transfers the text to the server 300 via his/her electronic device 100. The server 300 converts the text into multimedia 410, as shown in FIG. 7, including pictures or video, in order to allow for visual communication. To this end, the server 300 extracts words, to be converted to pictures or video, from the text. This extraction is performed via a morphemic analysis process for separating unprocessed texts by morphemes and a syntax analysis process for extracting a keyword. Alternatively, this can also be performed in such a manner that a period, a comma or a space is searched, a phrase is separated based on the searched period, comma, or space, a determination is made as to whether a syllable corresponding to a particle (or postpositional word) exists at the end of the phrase, for example, in Korean, and a keyword is extracted from the remaining part of the phrase, which excludes the particle (or postpositional word) from the phrase. Context may be recognized and analyzed via various symbols, such as, an exclamation mark or question mark, a number of periods consecutive, notes, tilde, etc.

At step S200, the server 300 extracts a picture corresponding to a text from the multimedia classification system DB 500. The extraction of a picture is performed in such a manner that the picture corresponds to the context and words, analyzed at step S100, in the multimedia classification system DB 500. The multimedia classification system DB 500 will be described in detail later, referring to FIG. 3.

At step S300, the server 300 creates an avatar representing the user. One avatar is created in general for one user, however, a number of avatars may be created for one user, if necessary. A detained description about avatars will be provided later, referring to FIGS. 4 and 5.

At step S400, the server 300 synthesizes the picture and the avatar into one multimedia form. As shown in FIG. 7, synthesis is performed in such a manner that an avatar 415 and an article image 413 are located at proper positions on the background image 411 so that the user can easily recognize them. A detailed description about multimedia will be provided later, referring to FIG. 7.

At step S500, the server 300 transfers the multimedia to the first user's microblog. That is, although the first user inputs only texts, the server 300 converts the texts into multimedia 410, as shown in FIG. 7, and then transfers them to the first user's microblog, thereby performing visual communication.

FIG. 3 illustrates a multimedia classification system DB that describes a visual communication method adapted to microblogs, according to an exemplary embodiment of the present invention.

Referring to FIG. 3, the multimedia classification system DB 500 is constructed with multimedia data and a classification system diagram and by collecting text samples to create multimedia (410 as shown in FIG. 7) serving to perform visual communication. The collection of text samples may be performed by extracting texts with a higher use frequency from contents provided from web service providers, such as me2day, Runpipe, Sayclub me, MSN messenger, Nate On, etc., and by searching for languages with a higher use frequency in daily life in order to supplement the extraction. The classification system diagram is configured based on primary words, and may be constructed in such a manner that words that are related to food, clothing and shelter, feelings, daily life, etc., and have a higher use frequency are classified by according to types and situations in order to select words, which will be used to produce pictures for visual communication, from among them. The multimedia data is classified into a background image (411 as shown in FIG. 7) and at least one or more article images (413 as shown in FIG. 7) placed on the background image 411. A search is made for a background image 411 or an article image 413 by matching a key word, extracted from a user's input text, to a text sample and via the classification system diagram. After that, the method proceeds with step S300.

FIGS. 4 and 5 illustrate views of an avatar that describes a visual communication method adapted to microblogs, according to exemplary embodiments of the present invention.

Referring to FIGS. 4 and 5, the avatar 415 representing the microblog user may be produced in two- or three-dimensions. For example, the avatar 415 may be produced by 3D computer graphics software, such as Autodesk Maya, Autodesk 3DS Max, etc. When an avatar is produced by 3D computer graphics software, it provides a realistic model that is similar to a real object. In addition, 3D computer graphics software may also produce an avatar in a simple form by modeling or illustrating only a user's features.

FIG. 6 illustrates a flow chart that describes in detail step S300 in the visual communication method shown in FIG. 2, according to an exemplary embodiment of the present invention.

Referring to FIG. 6, the creation of an avatar representing the user of step S300 is performed in such a manner that the server detects a user's feeling corresponding to the text using the multimedia classification system DB at step S310, and creates an avatar having a facial expression corresponding to the feeling at step 330.

At step S310, the server 300 detects a user's feeling corresponding to the text using the multimedia classification system DB 500. The server 300 can detect a user's feeling by matching the context and words, analyzed at step S100 to situations classified in the classification system diagram of the multimedia classification system DB 500. However, in order to prevent a case where the server 300 has difficulty detecting a user's feeling, the system may set pleasure as a default feeling.

At step S320, the server 300 creates an avatar 415 having a facial expression corresponding to the feeling. For example, the avatar 415 may be created by being synthesized with a facial image corresponding to the feeling detected at step S310, for example, pleasure, sorrow, anger, or the like, etc.

FIG. 7 illustrates one multimedia form that describes a visual communication method adapted to microblogs according to an exemplary embodiment of the present invention.

Referring to FIG. 7, the multimedia 410 includes a background image 411, an article image 413, and an avatar 415. The server 300 extracts a background image 411, ‘TOM N TOMS,’ via the words ‘TOM TOM,’ and an article image 413, ‘Pretzel,’ via the word ‘Pretzel,’ from a message ‘Together at TOM N TOMS Pretzel, waiting to see a movie again today [symbol] .’ Wherein, the message has been input to the first user' s electronic device 100, TOM N TOMS denotes a coffee store and Pretzel refers to a food name. Alternatively, the server 300 may also detect a user' s feeling via the note ‘ [symbol] ’ as pleasure. After that, one multimedia form 410 is produced in such a manner that the extracted image, ‘TOM N TOMS,’ is configured as the background image 411, the avatar 415 with a pleasure facial expression is placed on the center portion of the background image 411, and the article image 413, ‘PRETZEL,’ is positioned below the avatar 415.

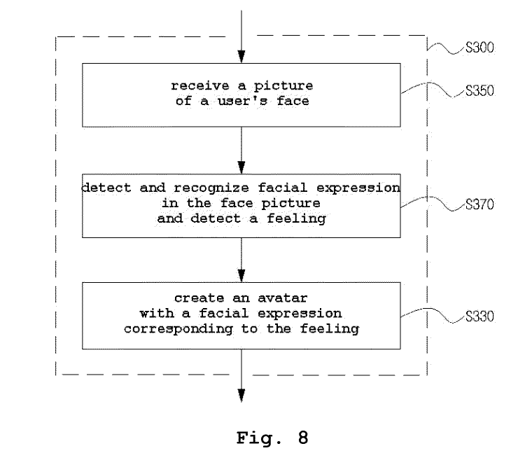

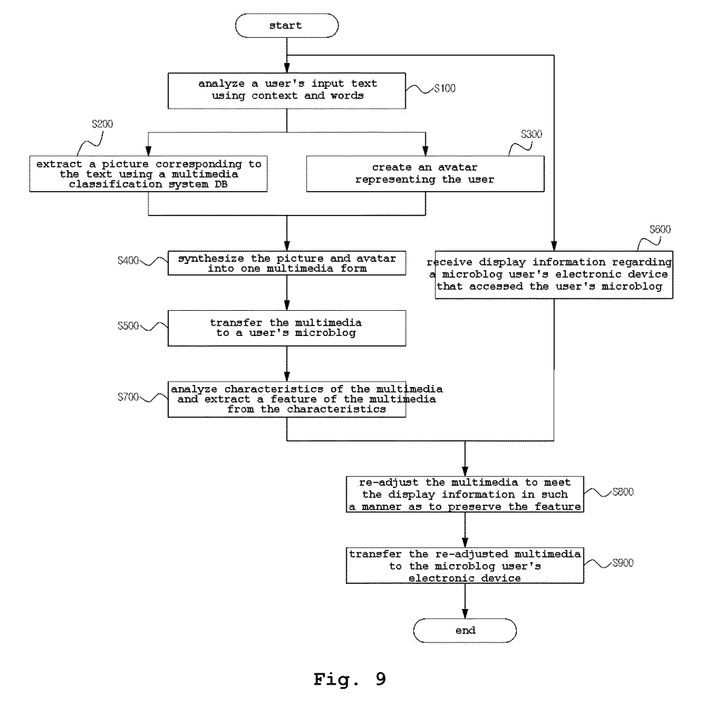

FIG. 8 illustrates a flow chart that describes in detail step S300 in the visual communication method shown in FIG. 2, according to another exemplary embodiment of the present invention.

Referring to FIG. 8, the creation of an avatar representing the user of step S300 is also performed in such a manner that the server receives the first user's face picture at step S350, recognizes and analyzes a facial expression in the face picture and detects a feeling at step S370, and creates an avatar having a facial expression corresponding to the feeling expressed at step S330.

At step S350, the server 300 receives the first user's face picture. The user takes a picture of his/her face via a camera of the first user's electronic device 100, and then transmits it from the electronic device 100 to the server 300. This process can express the first user's feelings on the first user's microblog 400 without using an additional mechanism such as a keyboard, a mouse device, a pointer, etc., thereby implementing a convenient method of user interface.

At step S370, the server 300 recognizes and analyzes a facial expression in the face picture and detects a feeling. Since a person's facial expression reveals the person's feeling, the server 300 recognizes the first user's facial expression, detects the feeling, and applies it to the contents in the microblog 400, such as an avatar 415, etc. Therefore, the system can invoke a user's interest, providing user convenience. In an embodiment of the invention, facial expression recognition is performed by Active Appearance Model (AAM). AAM supports the detection of a feeling by processing an input picture via a partial enlargement of a face, shape measurement, standard shape transformation, illumination removal, etc.

Since step S330 comprising another embodiment shown in FIG. 8 is the same process as that of the embodiment shown in FIG. 6, its detailed description is omitted in this section.

FIG. 9 illustrates a flow chart that describes a second embodiment of a visual communication method adapted to microblogs, according to an exemplary embodiment of the present invention.

The visual communication method of the second embodiment is performed in such a manner that the server performs all steps of the first embodiment, and the following additional steps receiving display information regarding a microblog user's (second user's) electronic device that accessed the first user's microblog at step S600, analyzing characteristics of the multimedia and extracting a feature of the multimedia from the characteristics at step S700, re-adjusting the multimedia to meet the display information in such a manner as to preserve the feature at step S800, and transferring the re-adjusted multimedia to the microblog user's (second user's) electronic device at step S900.

At step S600, the server 300 receives display information regarding a microblog user's (second user's) electronic device that accessed the first user's microblog. Images generally have fixed sizes, however, display units installed to electronic devices vary in type and size. Therefore, if a display unit displays an image that differs, in size, from the display unit, it displays a distorted image or an empty area without any image data. In order to prevent this problem, the server 300 receives information regarding the display of the electronic device. The display information includes at least one of the size, resolution, and frequency of the display unit.

At step S700, the server 300 analyzes characteristics of the multimedia and extracts a feature of the multimedia from the characteristics. The feature refers to a portion of multimedia into which a picture with a high degree of importance, such as an avatar 415, is inserted. The degree of importance is set in order of an avatar 415, an article image 413, and a background image 411. Extracting a feature from a background image 411 is performed based on the change in saturation. When the change in saturation does not occur or is a small area, the area is very likely to be a portion corresponding to sky or a wall, for example. In that case, the degree of importance is low. On the contrary, when the change in saturation rapidly increases or decreases in an area, the area is very likely to be a portion that directly shows the feature of the background image. In that case, the degree of importance is high. Detecting the degree of saturation change can be determined relatively easily for each picture. The server 300 extracts a feature based on the portion with a high degree of importance, so that the contents that the user intends to transmit via text cannot be distorted.

At step S800, the server 300 re-adjusts the multimedia to meet the display information in such a manner as to preserve the feature. The feature refers to a portion that contains contents that the first user intends to transmit. Therefore, the server 300 can re-adjust the multimedia by retaining the feature as it is and removing the remaining portion. A re-adjusting process may be one of re-sizing, cropping, rotating, brightness controlling, saturation controlling, etc.

At step S900, the server 300 transfers the re-adjusted multimedia to the microblog user's (second user's) electronic device. The server 300 transfers an optimal multimedia 410 to the display unit of the microblog user's (second user's) electronic device 200, so that the second user can detect the contents that the first user intends to transmit, without distortion.

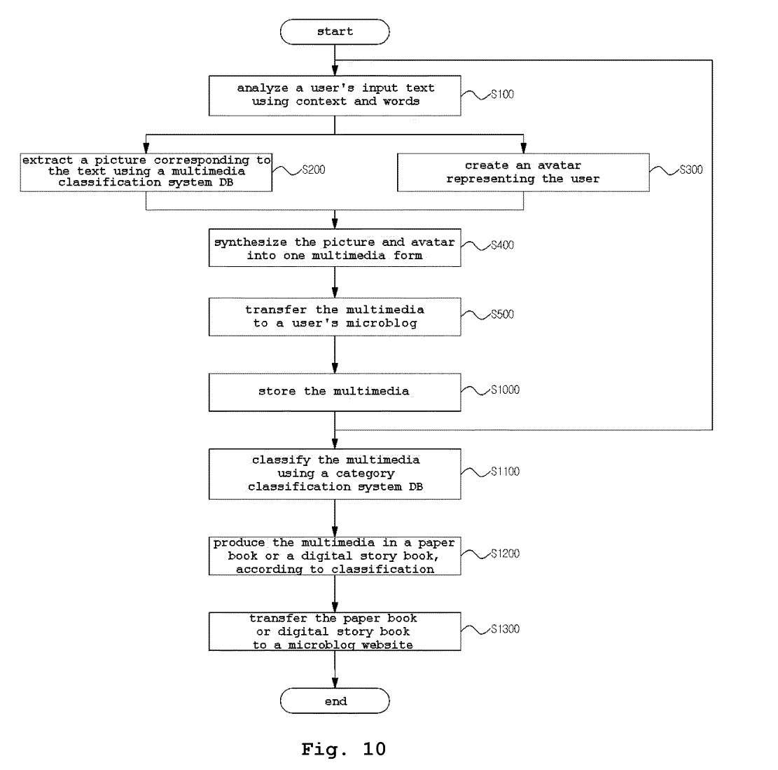

FIG. 10 illustrates a flow chart that describes a third embodiment of a visual communication method adapted to microblogs, according to an exemplary embodiment of the present invention.

Referring to FIG. 10, the visual communication method of the third embodiment is performed in such a manner that the server performs all steps of the first embodiment, and the following additional steps storing the multimedia at step S1000, classifying the multimedia using a category classification system data base (DB) at step S1100, producing the multimedia in a format of a paper book or a digital story book, according to the classification system at step S1200, and transferring the paper book or digital story book to a microblog website at step S1300.

At step S1000, the server 300 stores the multimedia. The server 300 may repeat steps S100 to S500 and S1000 in order to store a number of multimedia created from a number of users. The server 300 may include a storage space (not shown).

At step S1100, the server 300 classifies the multimedia using a category classification system data base (DB). The server 300 matches the contexts and words analyzed at step S100 to the category classification in the category classification system DB 600 shown in FIG. 11, thereby detecting the category of respective multimedia 410 and classifying them. A detailed description regarding the category classification system DB 600 will be provided later, referring to FIG. 11.

At step S1200, the server 300 produces the multimedia in a format of a paper book or a digital story book, according to the classification system. During this process, story-telling and a story line may also be configured. The server 300 can produce the multimedia in such a manner that it detects essential elements in the multimedia 410 shown in FIG. 7 and transfers them into data in order to create a story plot, and also it identifies, in real time, the amount of data required to form a story line.

At step S1300, the server 300 transfers the paper book or digital story book to a microblog website. The microblog website refers not to users' microblogs but to a main webpage that an operator of the server 300 operates. When users, who access a microblog website, use a paper or digital story book, they can access multimedia classified according to categories and easily acquire their desired information.

FIG. 11 illustrates a category classification system DB that describes a visual communication method adapted to microblogs, according to an exemplary embodiment of the present invention.

Referring to FIG. 11, the category classification system DB 600 refers to a data base that the server uses while classifying multimedia according to categories in order to produce a paper or digital story book. The server 300 complies a list of categories that can be used to produce a page or a digital story book from a number of multimedia that are posted to a number of users' microblogs. In addition, the server 300 can also extract sub categories from the category, thereby preparing a classification system diagram. The category classification system includes categories, sub-categories, and items.

As described above, the visual communication method according to the invention can allow a user to intuitively and easily post his/her message in a microblog by using a visual communication technique.

In addition, the visual communication method can extract a tweet corresponding to a particular category from a microblog, create a paper or digital story book, and allow for the use of information in the microblog.

Further, the visual communication method can produce an avatar that serves as a virtual character representing a user and can allow the avatar to express feeling and motion, so that users can operate microblogs with features and use them.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A visual communication method in a microblog where a user inputs text and another user views it in real-time, the method comprising:
(1) analyzing, by a server, a user's input text using context and words;
(2) extracting, by the server, a picture corresponding to the text using a multimedia classification system data base (DB);
(3) creating, by the server, an avatar representing the user;
(4) synthesizing, by the server, the picture and the avatar into one multimedia form; and
(5) transferring, by the server, the synthesized multimedia to the user's microblog.

2. The method of claim 1, wherein the creating of the avatar comprises:
detecting, by the server, a user's feeling corresponding to the text using the multimedia classification system DB; and
creating, by the server, an avatar having a facial expression corresponding to the feeling.

3. The method of claim 1, wherein the creating of the avatar comprises:
receiving, by the server, the user's face picture;
recognizing and analyzing, by the server, a facial expression in the face picture and detecting a feeling; and
creating, by the server, an avatar having a facial expression corresponding to the feeling.

4. The method of claim 1, further comprising:
(6) receiving, by the server, display information regarding a microblog user's electronic device that accessed the user's microblog;
(7) analyzing, by the server, characteristics of the multimedia and extracting a feature of the multimedia from the characteristics;
(8) re-adjusting, by the server, the multimedia to meet the display information in such a manner to preserve the feature; and
(9) transferring, by the server, the re-adjusted multimedia to the microblog user's electronic device.

5. The method of claim 1, further comprising:
(6) storing, by the server, the multimedia;
(7) classifying, by the server, the multimedia using a category classification system data base (DB);
(8) producing, by the server, the multimedia in a paper book or digital story book format, according to classification; and
(9) transferring, by the server, the paper book or digital story book to a microblog website.
